(19) United States
(12) Patent Application Publication
(10) Pub. No.: US 2013/0062562 A1
(43) Pub. Date: Mar. 14, 2013

(54) ALUMINATE-BASED FLUORESCENT POWDER COATED BY METAL NANOPARTICLE AND PRODUCTION METHOD THEREOF

(71) Applicants: Mingjie Zhou, Shenzhen (CN); Jun Liu, Shenzhen (CN); Wenbo Ma, Shenzhen (CN)

(72) Inventors: Mingjie Zhou, Shenzhen (CN); Jun Liu, Shenzhen (CN); Wenbo Ma, Shenzhen (CN)

(21) Appl. No.: 13/699,276

(22) PCT Filed: May 25, 2010
(86) PCT No.: PCT/CN2010/073222

§ 371 Date: Nov. 20, 2012

(51) Int. Cl. C09K 11/77; C09K 11/87

(52) U.S. Cl. CPC C09K 11/7774; C09K 11/873; Y10S 977/773; B82Y 30/00
USPC 252/301.4 R; 427/157; 977/773

(57) ABSTRACT

An aluminate-based fluorescent powder coated by metal nanoparticles. The formula thereof is (Y₁₋ₓTbₓ)₃(Al_{1-y}Ga_{y})₅O₁₂@zM, in which 0<x≦1.0, 0≦y≦1.0, @ means coating, M is metal nanoparticles, z is mole ratio of metal nanoparticles to aluminate-based fluorescent powder and 0<z≦0.01. A method for producing the aluminate-based fluorescent powder coated by metal nanoparticles is also provided.

### FIELD OF THE INVENTION

The invention relates to fluorescent powder material and production method thereof, more particularly, the invention relates to aluminate-based fluorescent powder excited by cathode ray and production method thereof.

### BACKGROUND OF THE INVENTION

At present, there are two types of commercial FED fluorescent powder: sulfide system and oxide system. The sulfide system including blue powder ZnS: Ag, Cl, SrGa₂S₄: Ce, green powder SrGa₂S₄: Eu and red powder Y₂O₂S: Eu. Although sulfide system has higher luminance, it has poor stability. The oxide system mainly includes blue powder Y₂SiO₅: Ce, green powder ZnGa₂O₄: Mn, Y₂SiO₅: Tb, Y₃Al₅O₁₂: Tb and red powder Y₂O₃: Eu. Oxide system has higher stability, but its luminance and conductivity is not as good as sulfide system. Therefore, in order to improve the conductivity of FED fluorescent powder, several methods are studied as following: using fluorescent material with conductivity or coating fluorescent powder surface with conductive material, such as In₂O₃, SnO₂, ZnO, etc. Or doping conductive ion into fluorescent powder, such as In³⁺, Li⁺, Na⁺, K⁺, etc. Or doping high concentration impurities into fluorescent powder as donor substance, it can reduce the conductivity of the fluorescent powder. Or modifying current commercial fluorescent powder, for example, controlling the morphology, particle size and uniformity of the fluorescent powder by different production methods, or a combination of different production methods, or taking advantage of core-shell material.

### SUMMARY OF THE INVENTION

The technical problem that the invention solves is to provide an aluminate-based fluorescent powder coated by metal nanoparticle which has high stability, uniform granularity and high luminescence intensity and production method thereof.

The technical solution to solve the technical problem in the present invention is: an aluminate-based fluorescent powder coated by metal nanoparticle is provided, said aluminate-based fluorescent powder coated by metal nanoparticle has the following chemical formula: (Y₁₋ₓTbₓ)₃(Al_{1-y}Ga_{y})₅O₁₂@zM, in which 0<x≦1.0, 0≦y≦1.0, @ means coating, metal nanoparticle M is one of Ag, Au, Pt, Pd, Cu, z is mole ratio of metal nanoparticle to aluminate-based fluorescent powder and 0<z≦1×10⁻². Herein, preferably, 0.20≦x≦0.60, 0.25≦y≦0.75, 1×10⁻⁴≦z≦5×10⁻³.

In the fluorescent powder of present invention, said metal nanoparticle M is one of Ag, Au, Pt, Pd, Cu. Preferably, 0.20≦x≦0.60, 0.25≦y≦0.75, 1×10⁻⁴≦z≦5×10⁻³.

And, production method of aluminate-based fluorescent powder coated by metal nanoparticle, comprising:

(a) producing metal nanoparticle colloid;

(b) surface treating the metal nanoparticle by adding metal nanoparticle colloid to the solution in which polyvinylpyrrolidone is dissolved;

(c) taking Al(NO₃)₃, Tb(NO₃)₃, Ga(NO₃)₃ and Y(NO₃)₃ solution in erlenmeyer flask stirring, heating in water-bath, adding to the final solution treated in step (b) directly and stirring uniformly to form mixed solution;

(d) forming mixed liquid by dissolving citric acid monohydrate in ethanol, adding said mixed liquid to the final mixed solution obtained in step (c), adjusting pH value to 3 to 5 by ammonia, sealing, keeping the temperature constant, drying and obtaining precursor;

(e) pre-calcinating the precursor obtained in step (d), then cooling to the room temperature, calcinating in reduction atmosphere after grinding, cooling, taking out and grinding to obtain said aluminate-based fluorescent powder coated by metal nanoparticle.

In the method of present invention, the preparation step of metal nanoparticle colloid in said step (a), comprising: dissolving metal compound in ethanol or water and diluting, then under stirring, mixing with one or more assistant agents and reducing agent successively, to obtain metal nanoparticle colloid. Said assistant agent is at least one of polyvinylpyrrolidone, sodium citrate, cetyl trimethyl ammonium bromide, sodium dodecyl sulfate, sodium dodecyl sulfonate, said reducing agent is at least one of hydrazine hydrate, ascorbic acid, sodium citrate, sodium borohydride.

In the method of present invention, in said step (c), the temperature of water-bath is 80° C.

In the method of present invention, in said step (d), the molar ratio of said citric acid monohydrate to total metal ion is 3:1, said temperature is kept constant for 3 to 6 h by stirring in an 80° C. water-bath. In said step (d), said drying condition is drying in blast drying oven at 60° C. for 12 hours, then drying at 100° C.

In the method of present invention, in said step (f), the temperature of said pre-calcination is in the range of 600 to 1250° C., the time of pre-calcination is in the range of 2 to 6 hours, the temperature of said calcination is in the range of 900 to 1400° C., the time of calcination is in the range of 2 to 5 hours. Said reducing atmosphere is any gas selected from mixed gas of nitrogen and hydrogen, pure hydrogen, and carbon monoxide.

Compared to the prior art, the core-shell structure fluorescent powder (Y₁₋ₓTbₓ)₃(Al_{1-y}Ga_{y})₅O₁₂@zM prepared in present invention doesn't need ball milling, it has high stability, uniform particle size and high luminous efficiency, it can be used in the field of FED as a green fluorescent powder. The present invention enhances the luminescence intensity of fluorescent powder by coating metal nanoparticle, and the luminescence intensity of fluorescent powder is higher than commercial fluorescent powder YAGG:Tb. The production method of present invention is simple, easy to prepare, no pollution, easy to control, suitable for industrial production; moreover, the production method of present invention does not introduce other impurities, obtain high quality products, can be widely applied in the preparation of the fluorescent powder.

### BRIEF DESCRIPTION OF THE DRAWINGS

Further description of the present invention will be illustrated, which combined with embodiments in the drawings:

FIG. 1 is the preparation flowchart of aluminate-based fluorescent powder coated by metal nanoparticle in the present invention.

FIG. 2 is an emission spectrum of fluorescent powder excited by cathode ray under 1.0 KV acceleration voltage in the example 2 of the present invention. Herein, curve a is the emission spectrum of the fluorescent powder (Y_{0.95}Tb_{0.05})₃Al₅O₁₂ with Ag metal nanoparticle; curve b is the emission spectrum of the commercial fluorescent powder YAGG:Tb; curve c is the emission spectrum of the fluorescent powder (Y_{0.95}Tb_{0.05})₃Al₅O₁₂ without Ag metal nanoparticle.

### DETAILED DESCRIPTION OF ILLUSTRATED EMBODIMENTS

Further description of the present invention will be illustrated, which combined with embodiments in the drawings, in order to make the purpose, the technical solution and the advantages clearer. While the present invention has been described with reference to particular embodiments, it will be understood that the embodiments are illustrative and that the invention scope is not so limited.

The present invention provides an aluminate-based fluorescent powder coated by metal nanoparticle, said aluminate-based fluorescent powder coated by metal nanoparticle has the following chemical formula: (Y₁₋ₓTbₓ)₃(Al_{1-y}Ga_{y})₅O₁₂@zM, in which 0<x≦1.0, 0≦y≦1.0, @ means coating, metal nanoparticle M is one of Ag, Au, Pt, Pd, Cu, Z is mole ratio of metal nanoparticle to aluminate-based fluorescent powder and 0<z≦1×10⁻².

In the fluorescent powder of present invention, said metal nanoparticle M is one of Ag, Au, Pt, Pd, Cu. Preferably, 0.20≦x≦0.60, 0.25≦y≦0.75, 1×10⁻⁴≦z≦5×10⁻³.

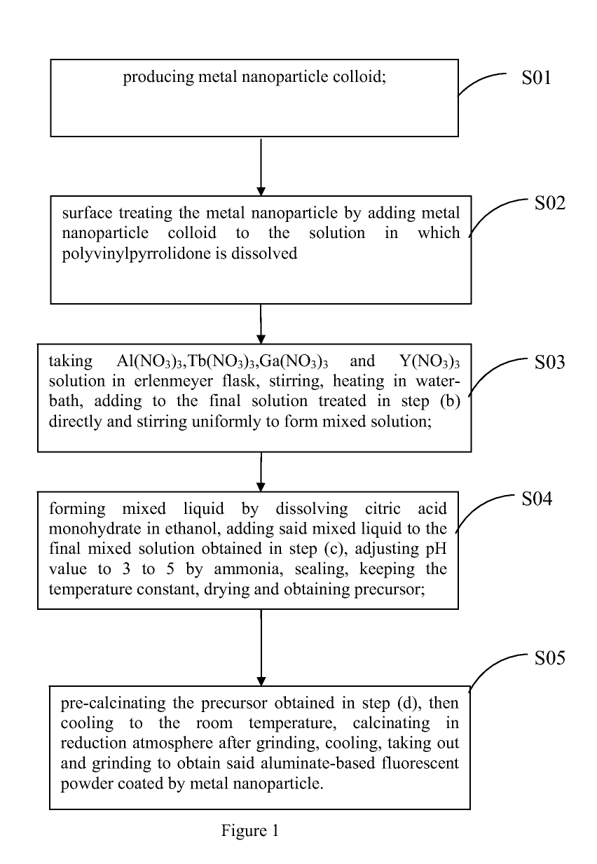

See FIG. 1; FIG. 1 shows the flow of the production method of the present invention, the production method comprises the following steps:

Step S01: producing metal nanoparticle colloid;

Step S02: surface treating the metal nanoparticle by adding metal nanoparticle colloid to the solution in which polyvinylpyrrolidone is dissolved;

Step S03: taking Al(NO₃)₃, Tb(NO₃)₃, Ga(NO₃)₃ and Y(NO₃)₃ solution in erlenmeyer flask stirring, heating in water-bath, adding to the final solution treated in step S02 directly and stirring uniformly to form mixed solution;

Step S04: forming mixed liquid by dissolving citric acid monohydrate in ethanol, adding said mixed liquid to the final mixed solution obtained in step S03, adjusting pH value to 3 to 5 by ammonia, sealing, keeping the temperature constant, drying and obtaining precursor;

Step S05: pre-calcinating the precursor obtained in step S04, then cooling to the room temperature, calcinating in reduction atmosphere after grinding, cooling, taking out and grinding to obtain said aluminate-based fluorescent powder coated by metal nanoparticle.

In the method of present invention, the preparation step of metal nanoparticle colloid in said step S01, comprising: dissolving metal compound in ethanol or water and diluting, then under stirring, mixing with one or more assistant agents and reducing agent successively, to obtain metal nanoparticle colloid. Said assistant agent is at least one of polyvinylpyrrolidone, sodium citrate, cetyl trimethyl ammonium bromide, sodium dodecyl sulfate, sodium dodecyl sulfonate, said reducing agent is at least one of hydrazine hydrate, ascorbic acid, sodium citrate, sodium borohydride.

In the method of present invention, in said step S03, the temperature of water-bath is 80° C.

In the method of present invention, in said step S04, the molar ratio of said citric acid monohydrate to total metal ion is 3:1, said temperature is kept constant for 3 to 6 h by stirring in an 80° C. water-bath. Said drying condition is drying in blast drying oven at 60° C. for 12 hours, then drying at 100° C.

In the method of present invention, in said step 505, the temperature of said pre-calcination is in the range of 600 to 1250° C., the time of pre-calcination is in the range of 2 to 6 hours, the temperature of said calcination is in the range of 900 to 1400° C., the time of calcination is in the range of 2 to 5 hours. Said reducing atmosphere is any gas selected from mixed gas of nitrogen and hydrogen, pure hydrogen, and carbon monoxide.

The core-shell structure fluorescent powder (Y₁₋ₓTbₓ)₃(Al_{1-y}Ga_{y})₅O₁₂@zM prepared in present invention doesn't need ball milling, it has high stability, uniform particle size and high luminous efficiency, it can be used in the field of FED as a green fluorescent powder. The present invention enhances the luminescence intensity of fluorescent powder by coating metal nanoparticle, and the luminescence intensity of fluorescent powder is higher than commercial fluorescent powder YAGG:Tb. The production method of present invention is simple, easy to prepare, no pollution, easy to control, suitable for industrial production; moreover, the production method of present invention does not introduce other impurities, obtain high quality products, can be widely applied in the preparation of the fluorescent powder.

Special examples are disclosed as follows to demonstrate production method and other features of aluminate-based fluorescent powder coated by metal nanoparticle.

### Example 1

### The Making of Fluorescent Powder Having Chemical Formula of (Y_{0.5}T_{0.5})₃(Al_{0.5}Ga_{0.5})₅O₁₂@ Au by Using Sol-Gel Coating Method

Weighting and dissolving 16.4 mg of chloroauric acid in 7.5 mL of ethanol, dissolved completely, stirring and adding 56 mg of sodium citrate and 24 mg of cetyl trimethyl ammonium bromide; weighting and dissolving 7.6 mg of sodium borohydride in 10 mL of ethanol, obtaining 10 mL of 0.02 mol/L alcoholic solution of sodium borohydride; under the condition of magnetic stirring, adding 2.5 mL of alcoholic solution of sodium borohydride into the alcoholic solution of chloroauric acid, continue to react for 30 min, then obtaining Au nanoparticle collosol containing 4×10⁻³ mol/L of Au; weighting and dissolving 0.2 g of PVP in 5 mL of deionized water; then adding 10 ml of 4×10⁻³ mol/L Au nanoparticle collosol, stirring for 24 h and to reserve.

Placing 10 mL of 1.0 mol/L Al(NO₃)₃ solution, 6.0 ml of 1 mol/L Y(NO₃)₃ solution, 10 ml of 1 mol/L Ga(NO₃)₃ solution and 6.0 ml of 1 mol/L Tb(NO₃)₃ solution into a conical flask, under the condition of magnetic stirring, heating in water-bath which is maintained at 80° C., then adding said metal nanoparticle collosol, stirring uniformly; weighting 6.7245 g of citric acid monohydrate (the amount is as much as the molar mass of metal ion) and dissolving in 30 ml of ethanol to make up solution, dripping the solution into the metal mixed solution, then adding ammonia water to adjust pH to about 3, sealing, placing into 80° C. water-bath, stirring, and keep the temperature constant for 3 h, drying in blast drying oven at 60° C. overnight, then drying completely at 100° C. to obtain precursor; placing the precursor into high temperature furnace and pre-calcinating at 600° C. for 6 h, cooling to the room temperature, grinding, then placing into tube furnace, calcinating in reducing atmosphere which is mixed gas of nitrogen and hydrogen (the volume ratio of N₂ to H₂ is 95:5) at 1200° C. for 3 h, naturally cooling, taking the precursor out and grinding, the desired fluorescent powder (Y_{0.5}Tb_{0.5})₃(Al_{0.5}Ga_{0.5})₅O₁₂@ Au is obtained.

### Example 2

### The Making of Fluorescent Powder Having Chemical Formula of (Y_{0.95}Tb_{0.05})₃Al₅O₁₂@ Ag by Using Sol-Gel Coating Method

Weighting and dissolving 3.4 mg of silver nitrate and 35.28 mg of sodium citrate in 18.4 mL of deionized water, stirring for 1.5 min, weighting and dissolving 3.8 mg of sodium borohydride in 10 mL of ethanol obtaining 0.01 mol/L alcoholic solution of sodium borohydride, dripping 1.6 ml of the alcoholic solution of sodium borohydride slowly into the solution of silver nitrate and sodium citrate; continue to react for 2 min, then obtaining 1×10⁻³ mol/L Ag nanoparticle collosol; weighting and dissolving 0.1 g of PVP into 7 ml of deionized water, the adding 0.5 ml of 1×10⁻³ mol/L Ag nanoparticle collosol, stirring for 12 h and to reserve.

Placing 12.5 mL of 2.0 mol/L Al(NO₃)₃ solution, 7.13 ml of 2 mol/L Y(NO₃)₃ solution and 3.75 ml of 0.2 mol/L Tb(NO₃)₃ solution into a conical flask, under the condition of magnetic stirring, heating in water-bath which is maintained at 80° C., then adding said metal nanoparticle collosol, stirring uniformly; weighting 16.8096 g of citric acid monohydrate (the amount is 2 times as much as the molar mass of metal ion) and dissolving in 30 ml of ethanol to make up solution, dripping the solution into the metal mixed solution, then adding ammonia water to adjust pH to about 4, sealing, placing into 80° C. water-bath, stirring, and keep the temperature constant for 6 h, drying in blast drying oven at 60° C. overnight, then drying completely at 100° C. to obtain precursor; placing the precursor into high temperature furnace and pre-calcinating at 800° C. for 5 h, cooling to the room temperature, grinding, then placing into tube furnace, calcinating in reducing atmosphere CO at 1300° C. for 4 h, naturally cooling, taking the precursor out and grinding, the desired fluorescent powder (Y_{0.95}Tb_{0.05})₃Al₅O₁₂@Ag is obtained. The fluorescent powder (Y_{0.95}Tb_{0.05})₃Al₅O₁₂ without metal nanoparticle-coating is prepared using the same method.

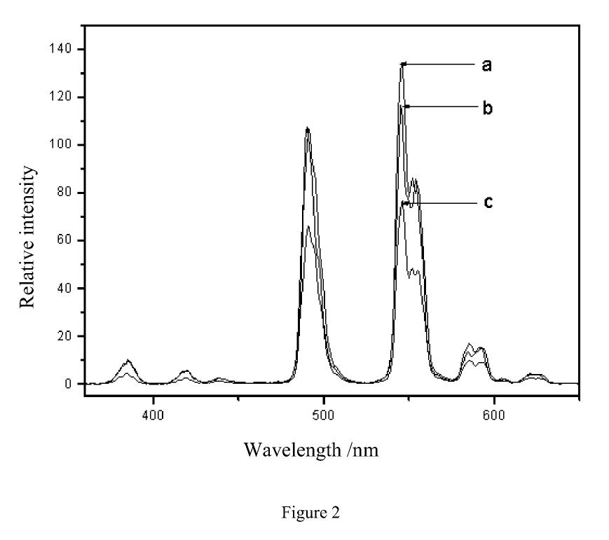

As shown in FIG. 2, FIG. 2 is an emission spectrum of fluorescent powder (Y_{0.95}Tb_{0.05})₃Al₅O₁₂@ Ag (curve a) excited by cathode ray under 1.0 KV acceleration voltage in the present example with respect to commercial fluorescent powder YAGG:Tb (curve b) and fluorescent powder (Y_{0.95}Tb_{0.05})₃Al₅O₁₂ (curve c). It can be seen from the emission peak at 546 nm, compared to the no metal nanoparticle coating fluorescent powder, the luminescence intensity of metal nanoparticle-coating fluorescent powder is increased by 76%, compared to the commercial fluorescent powder, the luminescence intensity of metal nanoparticle-coating fluorescent powder is increased by 16%.

### Example 3

### The Making of Fluorescent Powder Having Chemical formula of Tb₃(Al_{0.25}Ga_{0.75})₅O₁₂@ Pt by Using Sol-Gel Coating Method

Weighting and dissolving 5.2 mg of chloroplatinic acid in 17 mL of ethanol, dissolved completely, stirring and adding 8 mg of sodium citrate and 1.2 mg of sodium dodecyl sulfonate; weighting and dissolving 0.4 mg of sodium borohydride in 10 mL of ethanol, obtaining 1×10⁻³ mol/L alcoholic solution of sodium borohydride, dripping 0.4 mL of the alcoholic solution of sodium borohydride slowly into the mix solution of chloroplatinic acid, sodium citrate and sodium dodecyl sulfonate, reacting for 5 min, then adding 2.6 mL of 1×10⁻² mol/L aqueous solution of hydrazine hydrate, continue to react for 40 min, then obtaining Pt nanoparticle collosol containing 5×10⁻⁴ mol/L of Pt; weighting and dissolving 0.15 g of PVP in 6 mL of deionized water; then adding 5 ml of 5×10⁻⁴ mol/L Pt nanoparticle collosol, stirring for 18 h and to reserve.

Placing 5 mL of 1.0 mol/L Al(NO₃)₃ solution, 15 ml of 1 mol/L Ga(NO₃)₃ solution and 12 ml of 1 mol/L Tb(NO₃)₃ solution into a conical flask, under the condition of magnetic stirring, heating in water-bath which is maintained at 80° C., then adding said metal nanoparticle collosol, stirring uniformly; weighting 13.4490 g of citric acid monohydrate (the amount is 2 times as much as the molar mass of metal ion) and dissolving in 30 ml of ethanol to make up solution, dripping the solution into the metal mixed solution, then adding ammonia water to adjust pH to about 5, sealing, placing into 80° C. water-bath, stirring, and keep the temperature constant for 3 h, drying in blast drying oven at 60° C. overnight, then drying completely at 100° C. to obtain precursor; placing the precursor into high temperature furnace and pre-calcinating at 1000° C. for 3 h, cooling to the room temperature, grinding, then placing into tube furnace, calcinating in reducing atmosphere which is mixed gas of nitrogen and hydrogen (the volume ratio of N₂ to H₂ is 90:10) at 1200° C. for 5 h, naturally cooling, taking the precursor out and grinding, the desired fluorescent powder Tb₃(Al_{0.25}Ga_{0.75})₅O₁₂@ Pt is obtained.

### Example 4

### The Making of Fluorescent Powder Having Chemical Formula of (Y_{0.4}Tb_{0.6})₃(Al_{0.75}Ga_{0.25})₅O₁₂@ Pd by Using Sol-Gel Coating Method

Weighting and dissolving 0.43 g of palladium chloride in 15 mL of deionized water, dissolved completely, stirring and adding 1.1 g of sodium citrate and 0.4 g of sodium dodecyl sulfate; weighting and dissolving 0.038 g of sodium borohydride in 10 mL of ethanol, obtaining 0.1 mol/L alcoholic solution of sodium borohydride, dripping 5 mL of the alcoholic solution of sodium borohydride slowly into the mix solution of palladium chloride, sodium citrate and sodium dodecyl sulfate, reacting for 20 min, then obtaining Pd nanoparticle collosol containing 5×10⁻³ mol/L of Pd; weighting and dissolving 0.3 g of PVP in 5 mL of deionized water; then adding in 4 ml of 5×10⁻³ mol/L Pd nanoparticle collosol, stirring for 16 h and to reserve.

Placing 15 mL of 1.0 mol/L Al(NO₃)₃ solution, 5 ml of 1 mol/L Ga(NO₃)₃ solution, 4.8 ml of 1 mol/L Y(NO₃)₃ and 7.2 ml of 1 mol/L Tb(NO₃)₃ solution into a conical flask, under the condition of magnetic stirring, heating in water-bath which is maintained at 80° C., then adding said metal nanoparticle collosol, stirring uniformly; weighting 20.1734 g of citric acid monohydrate (the amount is 3 times as much as the molar mass of metal ion) and dissolving in 30 ml of ethanol to make up solution, dripping the solution into the metal mixed solution, then adding ammonia water to adjust pH to about 5, sealing, placing into 80° C. water-bath, stirring, and keep the temperature constant for 5 h, drying in blast drying oven at 60° C. overnight, then drying completely at 100° C. to obtain precursor; placing the precursor into high temperature furnace and pre-calcinating at 1250° C. for 2 h, cooling to the room temperature, grinding, then placing into tube furnace, calcinating in reducing atmosphere which is mixed gas of nitrogen and hydrogen (the volume ratio of N₂ to H₂ is 90:10) at 900° C. for 5 h, naturally cooling, taking the precursor out and grinding, the desired fluorescent powder (Y_{0.4}Tb_{0.6})₃(Al_{0.75}Ga_{0.25})₅O₁₂@ Pd is obtained.

### Example 5

### The Making of Fluorescent Powder Having Chemical Formula of (Y_{0.8}Tb_{0.2})₃Ga₅O₁₂@Cu by Using Sol-Gel Coating Method

Weighting and dissolving 2.3 mg of copper nitrate in 16 mL of ethanol, dissolved completely, stirring and adding 12 mg of PVP; weighting and dissolving 0.4 mg of sodium borohydride in 10 mL of ethanol, obtaining 1×10⁻³ mol/L alcoholic solution of sodium borohydride, dripping 4 mL of the alcoholic solution of sodium borohydride slowly into the mix solution of copper nitrate and PVP, reacting for 2 min, then obtaining Cu nanoparticle collosol containing 4×10⁻⁴ mol/L of Cu; weighting and dissolving 0.05 g of PVP in 5 mL of deionized water; then adding in 0.5 ml of 4×10⁻⁴ mol/L Cu nanoparticle collosol, stirring for 24 h and to reserve.

Placing 9.6 mL of 1.0 mol/L Y(NO₃)₃ solution, 2.4 ml of 1 mol/L Tb(NO₃)₃ solution and 20 ml of 1 mol/L Ga(NO₃)₃ solution into a conical flask, under the condition of magnetic stirring, heating in water-bath which is maintained at 80° C., then adding said metal nanoparticle collosol, stirring uniformly; weighting 13.4490 g of citric acid monohydrate (the amount is 2 times as much as the molar mass of metal ion) and dissolving in 30 ml of ethanol to make up solution, dripping the solution into the metal mixed solution, then adding ammonia water to adjust pH to about 4, sealing, placing into 80° C. water-bath, stirring, and keep the temperature constant for 6 h, drying in blast drying oven at 60° C. overnight, then drying completely at 100° C. to obtain precursor; placing the precursor into high temperature furnace and pre-calcinating at 900° C. for 6 h, cooling to the room temperature, grinding, then placing into tube furnace, calcinating in reducing atmosphere CO at 1400° C. for 2 h, naturally cooling, taking the precursor out and grinding, the desired fluorescent powder (Y_{0.8}Tb_{0.2})₃Ga₅O₁₂@ Cu is obtained.

### Example 6

### The Making of Fluorescent Powder Having Chemical Formula of (Y_{0.8}Tb_{0.2})₃(Al_{0.8}Ga_{0.2})₅O₁₂@Ag by Using Sol-Gel Coating Method

Weighting 0.0429 g of AgNO₃, 0.0733 g of sodium citrate, 0.05 g of PVP, and making up 10 ml of 0.025 mol/L aqueous solution of AgNO₃, 10 mL of 0.025 mol/L aqueous solution of sodium citrate, 10 mL of 5 mg/mL aqueous solution of PVP, respectively; adding 2 ml of aqueous solution of AgNO₃ and 4 ml of PVP into 30 ml of deionized water, stirring, heating to 100° C., then dripping 4 ml of aqueous solution of sodium citrate slowly into the solution of AgNO₃, reacting for 15 min, then obtaining Ag nanoparticle collosol containing 1×10⁻³ mol/L of Ag; weighting and dissolving 0.05 g of PVP in 4 mL of deionized water; then adding 5 ml of 1×10⁻³ mol/L Ag nanoparticle collosol, stirring for 24 h and to reserve. Placing 9.6 mL of 1.0 mol/L Y(NO₃)₃ solution, 2.4 ml of 1 mol/L Tb(NO₃)₃ solution and 16 ml of 1 mol/L Al(NO₃)₃ and 4 ml of 1 mol/L Ga(NO₃)₃ solution into a conical flask, under the condition of magnetic stirring, heating in water-bath which is maintained at 80° C., then adding said metal nanoparticle collosol, stirring uniformly; weighting 10.0868 g of citric acid monohydrate (the amount is 1.5 times as much as the molar mass of metal ion) and dissolving in 30 ml of ethanol to make up solution, dripping the solution into the metal mixed solution, then adding ammonia water to adjust pH to about 4, sealing, placing into 80° C. water-bath, stirring, and keep the temperature constant for 6 h, drying in blast drying oven at 60° C. overnight, then drying completely at 100° C. to obtain precursor; placing the precursor into high temperature furnace and pre-calcinating at 900° C. for 6 h, cooling to the room temperature, grinding, then placing into tube furnace, calcinating in reducing atmosphere H₂ at 1300° C. for 3 h, naturally cooling, taking the precursor out and grinding, the desired fluorescent powder (Y_{0.8}Tb_{0.2})₃(Al_{0.8}Ga_{0.2})₅O₁₂@ Ag is obtained.

While the present invention has been described with reference to particular embodiments, it will be understood that the embodiments are illustrative and that the invention scope is not so limited. Alternative embodiments of the present invention will become apparent to those having ordinary skill in the art to which the present invention pertains. Such alternate embodiments are considered to be encompassed within the spirit and scope of the present invention. Accordingly, the scope of the present invention is described by the appended claims and is supported by the foregoing description.

1. An aluminate-based fluorescent powder coated by metal nanoparticle, wherein said aluminate-based fluorescent powder coated by metal nanoparticle has the chemical formula of (Y₁₋ₓTbₓ)₃(Al_{1-y}Ga_{y})₅O₁₂@zM, in which 0<x≦1.0, 0≦y≦1.0, @ means coating, M is metal nanoparticle, z is mole ratio of metal nanoparticle to aluminate-based fluorescent powder and 0<z≦0.01.

2. The aluminate-based fluorescent powder coated by metal nanoparticle as in claim 1, wherein said metal nanoparticle M is one of Ag, Au, Pt, Pd, Cu.

3. The aluminate-based fluorescent powder coated by metal nanoparticle as in claim 1, wherein 0.20≦x≦0.60, 0.25≦y≦0.75, 1×10⁻⁴≦z≦5×10⁻³.

4. Production method of aluminate-based fluorescent powder coated by metal nanoparticle, comprising:
(a) producing metal nanoparticle colloid;
(b) surface treating the metal nanoparticle by adding metal nanoparticle colloid to the solution in which polyvinylpyrrolidone is dissolved;
(c) taking Al(NO₃)₃, Tb(NO₃)₃, Ga(NO₃)₃ and Y(NO₃)₃ solution in erlenmeyer flask, stirring, heating in water-bath, adding to the final solution treated in step (b) directly and stirring uniformly to form mixed solution;
(d) forming mixed liquid by dissolving citric acid monohydrate in ethanol, adding said mixed liquid to the final mixed solution obtained in step (c), adjusting pH value to 3 to 5 by ammonia, sealing, keeping the temperature constant, drying and obtaining precursor;
(e) pre-calcinating the precursor obtained in step (d), then cooling to the room temperature, calcinating in reduction atmosphere after grinding, cooling, taking out and grinding to obtain said aluminate-based fluorescent powder coated by metal nanoparticle.

5. The production method as in claim 4, wherein, the production method of metal nanoparticle colloid in said step (a), comprising: dissolving metal compound in ethanol or water and diluting, then under stirring, mixing with one or more assistant agents and reducing agent successively, to obtain metal nanoparticle colloid.

6. The production method as in claim 5, wherein, said assistant agent is at least one of polyvinylpyrrolidone, sodium citrate, cetyl trimethyl ammonium bromide, sodium dodecyl sulfate, sodium dodecyl sulfonate, said reducing agent is at least one of hydrazine hydrate, ascorbic acid, sodium citrate, sodium borohydride.

7. The production method as in claim 4, wherein, in said step (c), the temperature of water-bath is 80° C.; in said step (e), said reducing atmosphere is any gas selected from mixed gas of nitrogen and hydrogen, pure hydrogen, and carbon monoxide.

8. The production method as in claim 4, wherein, in said step (d), the molar ratio of said citric acid monohydrate to total metal ion is 3:1, said temperature is kept constant for 3 to 6 h by stirring in an 80° C. water-bath.

9. The production method as in claim 4, wherein, in said step (d), said drying condition is drying in blast drying oven at 60° C. for 12 hours, then drying at 100° C.

10. The production method as in claim 4, wherein, in said step (f), the temperature of said pre-calcination is in the range of 600 to 1250° C., the time of pre-calcination is in the range of 2 to 6 hours, the temperature of said calcination is in the range of 900 to 1400° C., the time of calcination is in the range of 2 to 5 hours.

11. The aluminate-based fluorescent powder coated by metal nanoparticle as in claim 2, wherein 0.20≦x≦0.60, 0.25≦y≦0.75, 1×10⁻⁴≦z≦5×10⁻³.
